(19) United States
(12) Patent Application Publication
(10) Pub. No.: US 2014/0372655 A1
(43) Pub. Date: Dec. 18, 2014

(54) System and Method for Symmetrical Direct Memory Access (SDMA)

(71) Applicant: Pete Neil Moore, Morgan Hill, CA (US)

(72) Inventor: Pete Neil Moore, Morgan Hill, CA (US)

(73) Assignee: Moore Performance Systems LLC, Morgan Hill, CA (US)

(21) Appl. No.: 13/920,095

(22) Filed: Jun. 18, 2013

(51) Int. Cl. G06F 13/28

(52) U.S. Cl. CPC G06F 13/28
USPC 710/308

(57) ABSTRACT

This invention defines a System and Method for optimized Data Transfers between two Processing entities, (typically done with DMA technology). We will call this invention and method, Symmetrical DMA, or SDMA.

SDMA is more efficient than legacy methods, by providing minimal latency, and maximum Bus utilization. SDMA is a Symmetrical Write-only “Push” model, where ALL Read operation inefficiencies are removed. SDMA is ideal for connecting Software programmable entities, over a bus or media, where the operations are Symmetrical and the overheads are balanced.

The present invention relates to multiple Computing Processors connected over Bus or Media, that transfer information between each other. A prime example is two Processors connected via a PCIE bus, (or PCI, PCIX, or similar buses, that allow devices to access a portion of each other's memory).

This invention does not define attributes of PCI, PCIX, PCIE, (all well known indusrtry standard Bus/interconnects), or any other bus/interconnect. This invention resides a layer above the Bus details, and is applicable for any Bus/Interconnect that is “PCI-like”, which allows devices to access a portion of each other's memory.

### BACKGROUND OF THE INVENTION

Legacy Host/Device Method (FIGS. 1a, 1b, 1c)

Typically Processors connected over a bus, will be deployed in a Host/Device configuration, and the side behaving as the Device will do most Read and Write transfers, to and from Host Memory. This will be referred to as the “legacy host/device model”. In this traditional model data transfers are normally managed by Descriptor Rings in Host Memory. Host Software defines the Ring Addresses and Size, then notifies the Devices by writing to Device Registers or defined Device Memory locations.

For Hardware Devices the Descriptor Rings fields and format are defined by a the Hardware Specifications. But for a Programmable Device the Descriptor Ring fields and format are normally defined within the Host Driver Software and Device Software/Firmware and have more flexibility, as long as both sides are programmed to understand the supported format.

The two main functions of Descriptor Rings are to: a) manage Data/Packet Buffers used for the real payload Data Transfers, and b) synchronize the Transfers in each direction. Normally there is a Receive Direction, Device to Host, and a Transmit direction, Host to Device. In this Host/Device legacy model, the Host Software pre-programs Packet Buffers into the Receive Descriptors, waiting for the Device to deposit new Receive Packets. An Ownership bit for each descriptor is used to indicate if the Buffer is available for the Device to use for new Packets or if is Pending processing on the Host Side. Reference FIG. 1b, for basic Descriptor Ring format.

The Device side fetches the Receive Descriptors, to acquire Receive Packet Buffer information, uses the Buffers for new packets, then updates the Descriptor for the Host to process. The Host Software also programs Host side packet buffer addresses into the Transmit descriptors, but only when it has a packet to Transmit. Notification methods are implementation dependent, but the Host side often writes to a Device side register or memory offset, to indicate the descriptor rings have been updated, and the Device side often triggers an interrupt or some other Notification method to indicate the Host should re-poll for new packets. Reference FIG. 1a for Descriptor and buffer flows.

The Host/Device model described above and illustrated in FIG. 1a is the “legacy model” because Devices are traditionally Hardware devices that are DMA (Direct Memory Access) capable, and Hosts are traditionally Software Programmable devices. Hardware devices can normally do the Bus transfers with DMA faster than Software. Additionally it is desired to offload Bus operations from the Host processor to allow it to move on to other high speed processing. Reference FIG. 1c, for Device Side DMA and Host Side CPU access illustration.

Bus Operation Efficiency (FIGS. 3a, 3b)

When implementing a Bus Data Transfer model it is desirable to eliminate Bus Read operations and design the system for Write Only as much as is possible. Because the remote side is not able to always prefetch the data, Read operations are always slower and have a higher Latency, while Write Bus operations have a lower latency and are more efficient. For Bus types similar to PCIX, where Reads and Writes compete for Bus Bandwidth, this issue is extreme, since the Bus can be idle while waiting for Read Fetches to complete, resulting in poor Bus Utilization in both directions. This has less impact for a Full Duplex Bus, like PCIE, with each direction having it's own reserved media, but is still applicable. Reference FIG. 3a (Bus Write) and FIG. 3b (Bus Read).

This is true for DMA but is an even larger issue for non-DMA processor Bus Read operations since they can Stall the processor Pipeline, waiting for the Read Data to be returned. Even on Multi-Issue Multi-staged Processors, Read operations can result in lost processing power, while Write operations are “Posted-Writes” and do not hold up the Processor pipeline. The SDMA invention is a Symmetrical 100% “Push Model”. It has zero Read operations, and only Write operations. SDMA transfers can be performed with Hardware DMA Write operations or Processor Posted-Writes, or a mix, (such as CPU for short writes and DMA for larger bursts).

### SUMMARY OF THE INVENTION

At a conceptual level this invention covers “Pushing” Descriptor information to remote sides before the information is needed. It eliminates all Read latencies and inefficiencies, reduces overall latency, reduces latency between payload transfers, and more efficiently utilizes Bandwidth in both directions—even when the direction utilization is unbalanced.

In addition to “Pushing” Descriptor information with Write operations, SDMA also eliminates Reads for the actual “payload” Data Transfer. In the SDMA model, transfers in either direction are implemented with “Write” operations. Again, ALL Reads are eliminated.

Disregarding terminology details the above concept statement applies to the SDMA invention when compared to Data transfer implementations between two Processing Entities. Additionally, implementation details can fluctuate, such as: Descriptor format details, field word and bit names, and interpretation details of such names and fields. Disregarding these types of implementation details, the conceptual statement above applies to the SDMA invention when compared to Data transfer implementations between two Processing Entities.

Some Asymmetrical Hardware assist solutions also push Descriptors across a bus—in some form—to help manage Buffers and Buffer Descriptors for a Processing Entity. The SDMA invention is distinctly unique from these solutions in that it covers uni-directional or bi-directional traffic between Processing Entities with transfers in either direction processed Symmetrically and eliminating Read latencies and reducing overall latency, in BOTH directions, as described above.

SDMA has these attributes:
Symmetrical Model; each side behaves exactly like the other
100% Push model; Read operations eliminated, only Write operations
Minimum possible Latency
Capable of running Buses at near 100% efficiency
Ideal for Dual Programmable Processors connected over a bus
Can also be deployed in Hardware logic

### BRIEF DESCRIPTION OF THE DRAWINGS

The present invention is illustrated by way of example, and not limitation, in the figures of the accompanying drawings in which like reference numerals refer to similar elements and in which:

FIGS. 1a, 1b, and 1c, illustrates the legacy host/device model.

FIG. 2a illustrates the SDD model, between a Host and Device, across a PCIE bus

FIG. 2b illustrates the SDD model, between two Hosts, across a PCIE bus

FIG. 2c illustrates the SDD model, between two Virtual Machines, over the System Bus

FIGS. 3a and 3b, illustrate typical Bus Write and Bus Read operations

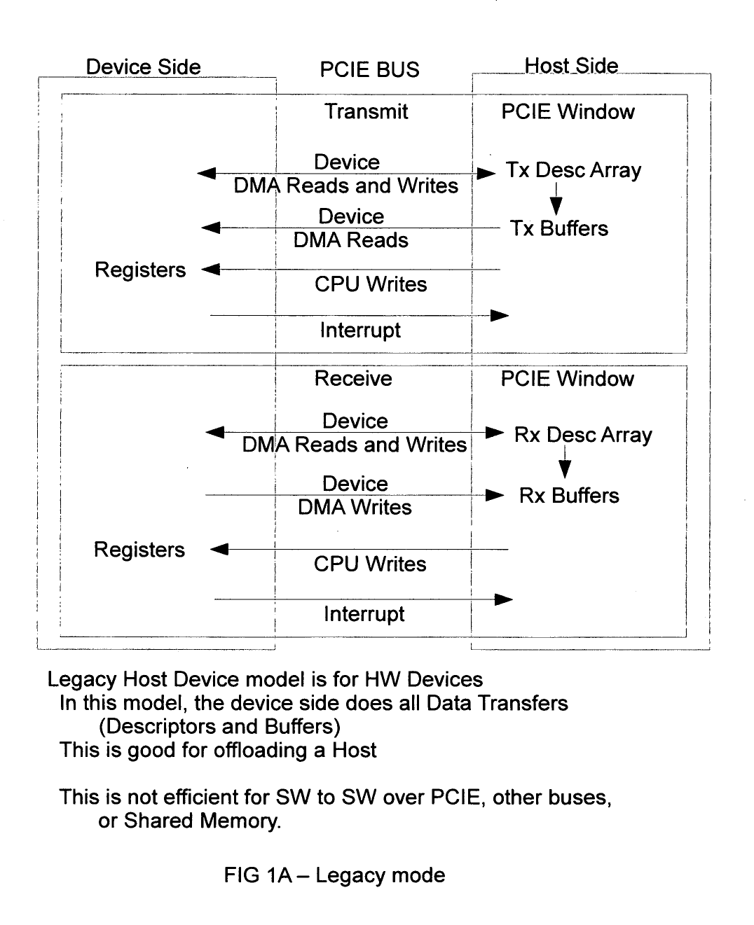

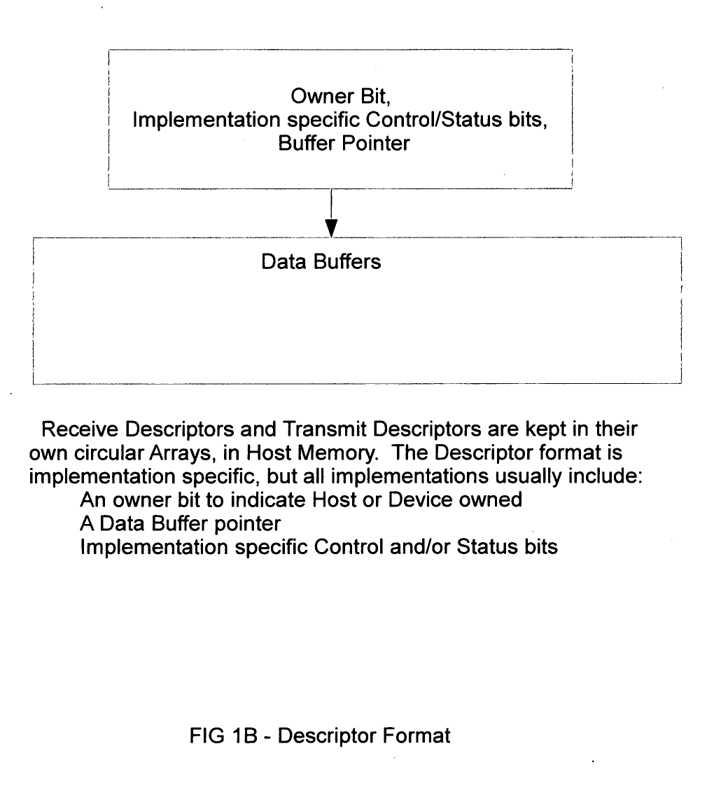

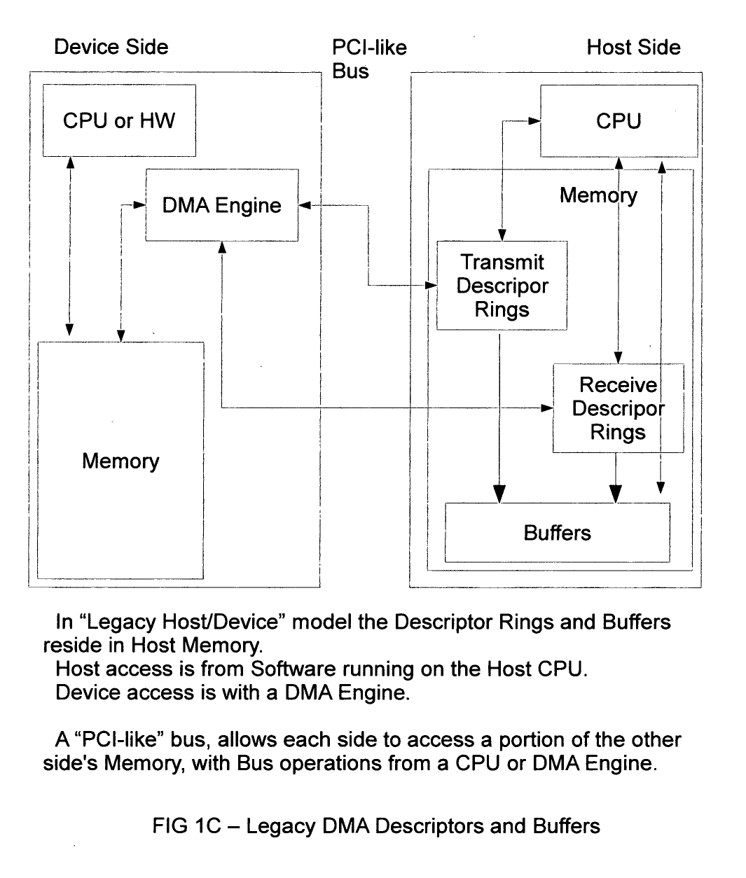

### DETAILED DESCRIPTION OF THE INVENTION

Again, the primary objective and value of the SDMA model is to minimize Bus operation Latency, maximize Bus utilization, and minimize Loss of Processing and/or Data Transfer power. We achieve all of the above, by completely eliminating Read operations, and making all transfers Write operations.

A secondary objective is to provide a Balanced Data transfer model that is better suited for two Processing Entities, than the “Legacy Host/Device” model, that is suited for unbalanced transfers between a Processing Entity and a Hardware Device.

In the paragraphs below, we explain how SDMA is implemented as a Write Only Data Transfer model, that operates Symmetrically and balanced, on both sides.

In the SDMA Symmetrical model Descriptors and Transfer operations are the same in each direction. There is no distinction of Receive vs. Transmit descriptors or operation flows. In this Symmetrical model, terminology can be more confusing when discussing or working with transfers in both directions. In this discussion, the Inventor will define all SDMA Descriptors as Receive Descriptors with the direction relative to each side in a local and remote sense.

SDMA Receive descriptors are kept and maintained on both sides, for both directions. Again, the Symmetrical model can be confusing this way. For each queue, in each direction, we define a “Local Receive Descriptor” and a “Remote Receive Descriptor”. The Local Receive Descriptor is where Receive Packets are processed. The Remote Receive Descriptor is for pushing Descriptor information to the Remote Side, so the Remote side can Transmit to this Queue. The Remote Receive Descriptor resides on the Transmit side of the PCIE or other Bus. Buffer and Descriptor Addresses are translated as needed, for access across the Bus.

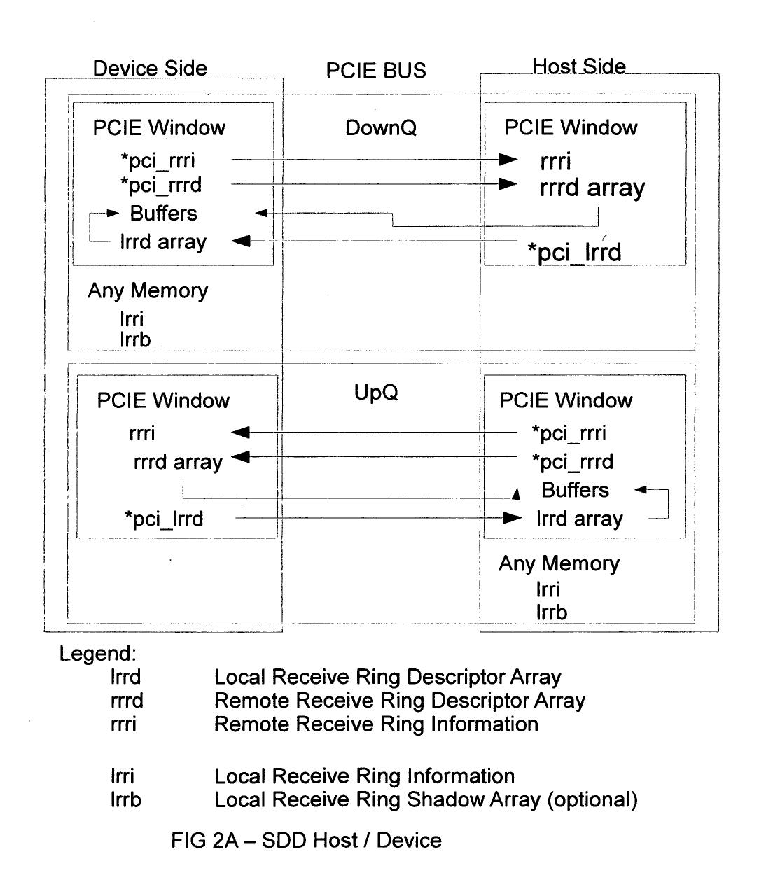

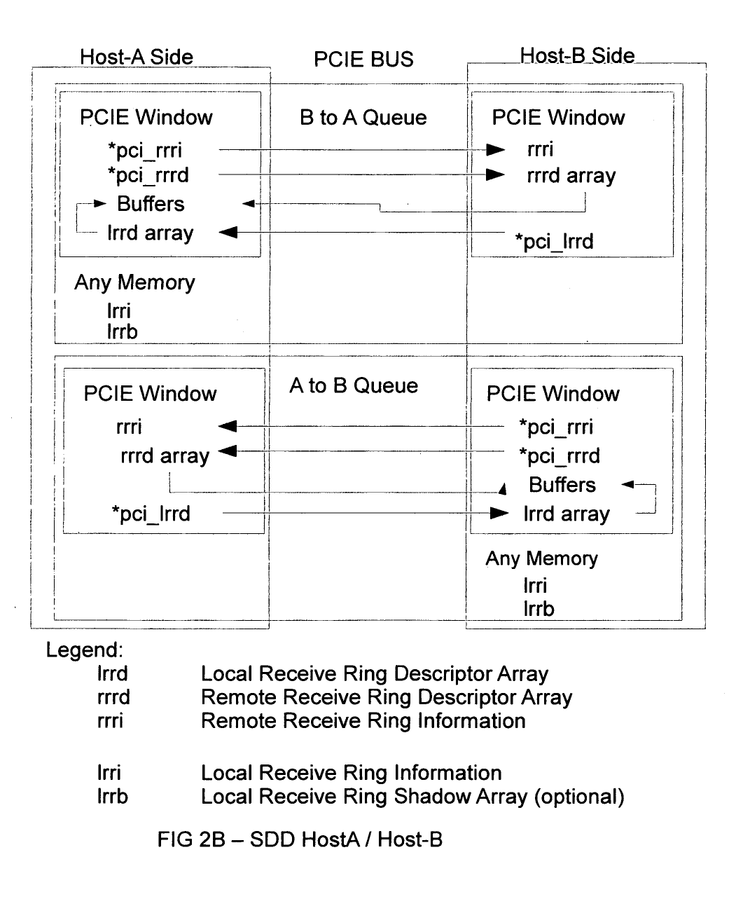

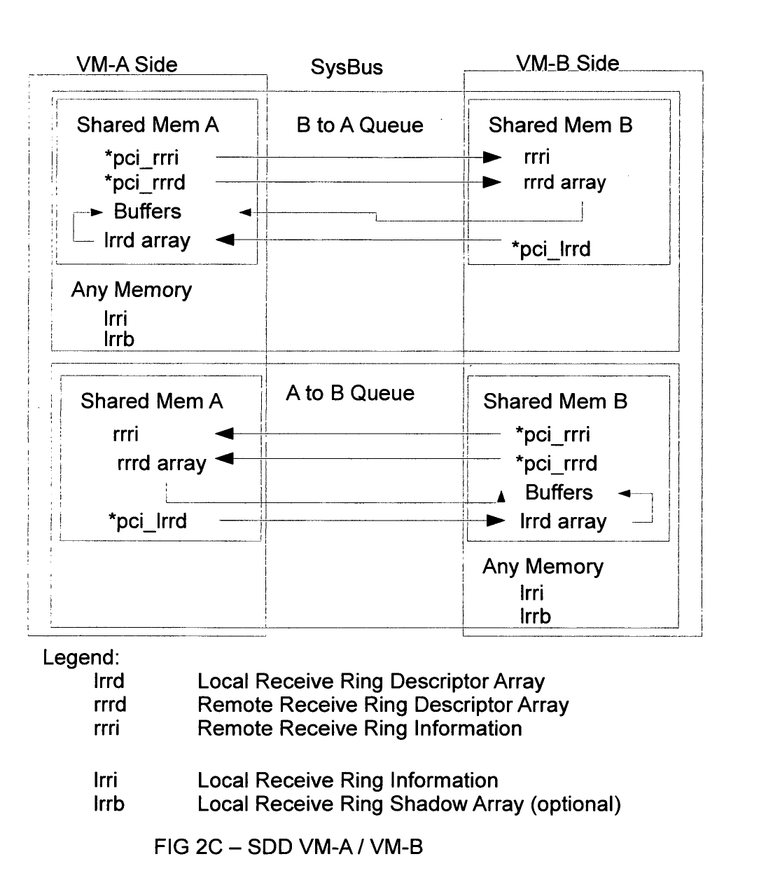

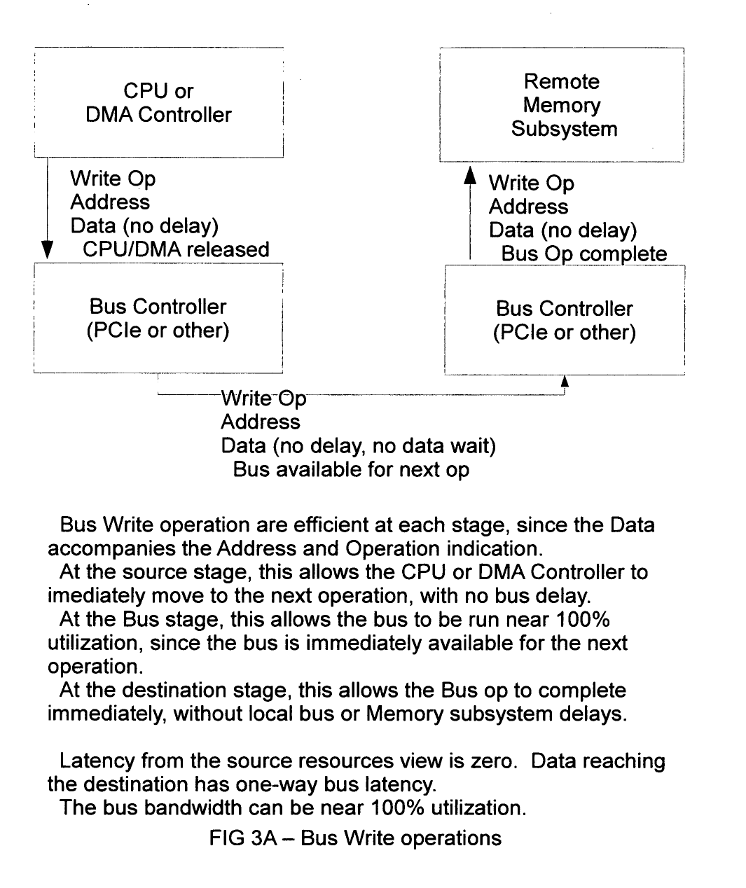

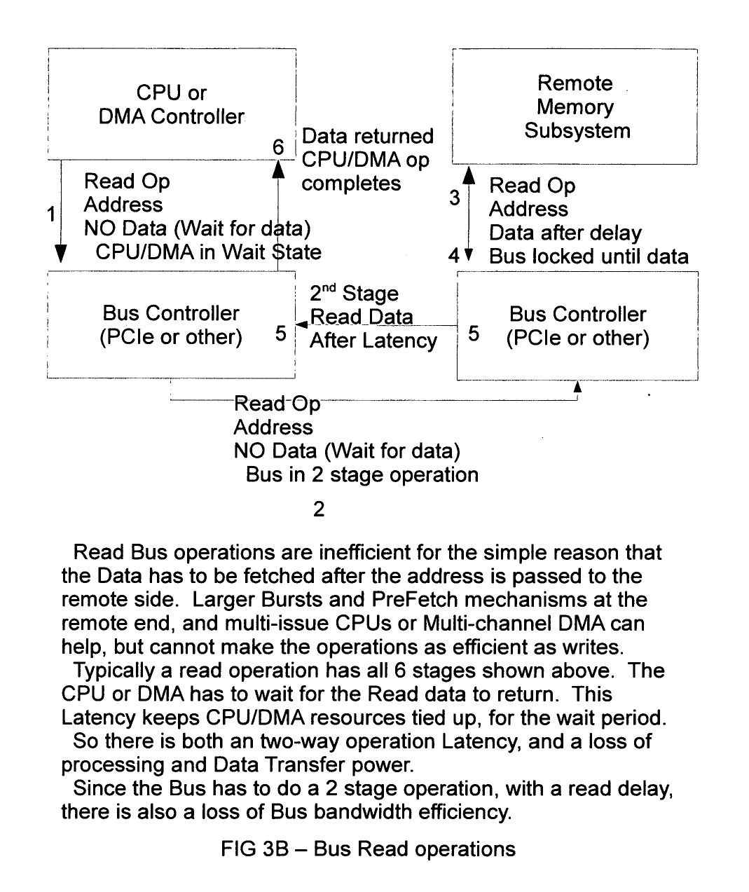

Reference FIGS. 2a-2c, to see the Structure types needed for the SDD Model. In these Drawings, you will see that the Receive Descriptor information is pushed over the PCIE Bus, (or other Bus), in the rrri (Remote Receive Ring Information), and the rrrd array (Remote Receive Ring Descriptor). The Transmit side uses this information to do the Data Transfers, by pushing Data Packets over the bus, into designated Receive Buffers. The Transmit side then notifies the Recieve side, by pushing over an updated lrrd (Local Receive Ring Descriptor). Again, the implementation must translate Buffer and Descriptor Addresses, as needed, for proper access across the Bus.

As said, all Bus accesses are Writes. There are zero Reads. When the Receive side adds Buffers to the Ring it updates both the Local and Remote sides so both sides can see the Ring state with local Memory and Cache accesses. When the Remote side wants to do a Transmit it checks the Remote Ring State to see if a Buffer is available, then pushes the Packet across the PCIE, or other Bus. Queues going in the opposite direction behave identically with the Local and Remote sides reversed. Again, the SDD model can be confusing since both sides behave identically and have the same Structures in reverse.

The above definitions are adequate for discussing one direction at a time. But when discussing or deploying SDMA in both directions the two directions must also be differentiated. With some implementations, like Host to Intelligent NIC, the terms “Upload” and “Download”, are applicable and useful. However, with two Host systems connected to each other, terms such as “Host-X” and “Host-Y”, might be more applicable. Where X and Y are letters, numbers, or names, to help distinguish a Host like system.

SDMA provides an improved design with improved performance over legacy and current implementations. SDMA defines a more efficient model that can be easily applied when both sides are Software or Firmware Programmable devices, though the invention and model can also be applied to a Hardware Unit on either side.

There are a number of deployments well suited for SDMA. A prime example of Dual Programmable Sides is a Programmable, or Intelligent NIC (Network Interface Controller) connected to a Host Processor. While traditional NICs are Hardware devices, there has been an industry shift to also deploy Intelligent/Programmable NICs, that can be used as more advanced and customizable “Offload Engines”, to increase Network Processing Performance and Functionality. Another common deployment is connecting System or Blade Processors together, over PCIE, or other buses. In these cases, both processors would normally be a Host processor, and are not ideal matches for the Host/Device Legacy model.

These deployments can include Systems designed with multiple processors, MultiBlade Servers, or on separate Units connected with PCIE over Cable, (or similar Bus over cable solutions). Connectivity can be direct to Host PCIE/(other bus) controllers, over PCIE/(other bus) Switches or PCIE/(other bus) over Cable.

Another common deployment, is for connecting VMs (Virtual Machines), within a Hypervisor based System, using Shared Memory connecting the VMs, and/or a Driver propagating the transfers between VM private memory space.

SDMA provides a Symmetrical model that is better suited for Host to Host, is efficient, has much lower latency, and the ability to run the Bus or Media at a higher BandWidth efficiency. Transfers can utilize a Host's Hardware DMA Controller, or Processor Write operations, or a combination of both. After SDMA becomes more of a standard, it is anticipated that SDMA will be integrated into Hardware deployments, due to the increase efficiency and lower latency. But early implementations are expected to be with Software/Firmware Programmable Processors, similar to the examples above.

The SDMA model can be deployed with any computing systems and devices connected across a bus. It is not OS specific, or processor architecture specific. One skilled in the art, could deploy SDMA on any system, bus, and devices. Again, the write operations can be performed by a Processor, or with a Hardware DMA Engine.

What is claimed is:

1. A system comprising of multi-devices, that are connected across a system Bus or Media, and implement a Data Transfer model across the Bus, that uses only efficient Write operations, and zero Read operations. Data Transfers can be uni-directional or bi-directional.

2. A method comprising: an efficient write-only, push data transfer model, that operates symmetrically between 2 processing entities, over a “bus”, or “media”.

3. A method of claim 2, wherein Receive Descriptor information, used to define destination buffers and synchronize data transfers, are pushed to the remote Transmit side, in advance, with Write-only operations, to eliminate all Read Latency and related inefficiencies.

4. A method of claim 2, wherein all “Payload” Data Transfers are performed with efficent Write operation, and zero Read operations. In both directions on the bus.

5. A method of claim 2, wherein all Read operations over the bus or media, are eliminated, and only Write operations occur in both directions.

6. A method of claim 2, wherein Receive Descriptor information is maintained on both the local, (Receive side), and remote, (Transmit side), for more efficient transfers.

7. A method of claim 2, that can be applied bidirectionally symmetrical, between 2 processing entities, for efficient and balanced data transfers.

8. A method of claim 2, that is balanced and ideal for connecting multiple devices, implemented as Software entities.

9. A method of claim 2, that can optionally be implemented with Hardware assist on either, or both sides.

10. A method of claim 2, that can push data over the bus with CPU instructions, or with a local DMA Engine, or a combination of both, such as short burst descriptors with CPU instructions but larger data packets with a DMA engine.
